(19) United States
(12) Patent Application Publication
(10) Pub. No.: US 2013/0246946 A1
(43) Pub. Date: Sep. 19, 2013

(54) SHARING USER INFORMATION THROUGH SECONDARY DISPLAYS

(71) Applicant: Jill S. IWASAKI, San Diego, CA (US)

(72) Inventor: Jill S. IWASAKI, San Diego, CA (US)

(73) Assignee: QUALCOMM INCORPORATED, San Diego, CA (US)

(21) Appl. No.: 13/420,494

(22) Filed: Mar. 14, 2012

(51) Int. Cl. G06F 3/048

(52) U.S. Cl. CPC G06F 3/048
USPC 715/761

(57) ABSTRACT

Information sharing is disclosed between a rich user device and one or more secondary display devices. A user selects types of information at the rich user device to be shared with the secondary display devices. On selection, the rich user device sends the selected information sets to the secondary display devices for display. When updates of the information are detected at the rich user device, those updates are sent along to the secondary display devices to display the new, updated information.

### BACKGROUND

1. Field

Aspects of the present disclosure relate generally to electronic user interfaces, and more particularly, to sharing user information through secondary displays.

2. Background

Over the last number of years, the availability and market penetration of mobile electronics into society has greatly increased. Smart phones are quickly outpacing voice-only mobile phones or enhanced feature phones in sale and placement into the market. In addition to smart phones, people are obtaining tablet computers, notebook and netbook computers, and other portable computing devices to supplement communication, productivity, life organization, and maintaining connectivity to social media.

Many current mobile electronic devices provide operational platforms for supplemental applications, whether provided through independent third parties, network operators, manufacturers, or the like. Thus, in addition to maintaining a calendar, email access, internet access, and communication functionalities, many such modern electronic devices provide computer platforms for various types of applications, such as supplemental communication applications, games and entertainment, social media applications, visual media development environments, productivity applications, and the like.

One of the reasons behind the growth in such mobile electronics is the desire to remain connected to other people. Friends may interact through social media, short messaging service (SMS) or text messages, email, and the like. Families may remain connected similarly and also coordinate schedules, todo lists, shopping lists, and the like. However, while such advanced mobile electronics are becoming an increasing part of everyday life, maintaining communications with friends or family through all of the various means for maintaining communications can become an extremely time-consuming process.

### SUMMARY

Representative aspects of the present disclosure are directed to sharing information between a rich user device and one or more secondary display devices. A user selects types of information at the rich user device to be shared with the secondary display devices. On selection, the rich user device sends the selected information sets to the secondary display devices for display. When updates of the information are detected at the rich user device, those updates are sent along to the secondary display devices to display the new, updated information.

In one aspect of the disclosure, a method for sharing information that includes receiving, at a rich user device, selection of one or more information sets maintained through the rich user device to share with one or more secondary display devices associated with the rich user device, identifying, by the rich user device, current data associated with the selected one or more information sets, and sending, by the rich user device, the identified current data to the one or more secondary display devices for display.

In an additional aspect of the disclosure, a method for sharing information that includes receiving, by a secondary display device, one or more information sets from a rich user device, wherein the secondary display device has a dedicated communication pairing with the rich user device, displaying the one or more information sets on the secondary display device, receiving, by the secondary display device, updates to the one or more information sets from the rich user device, and replacing the one or more information sets with the received updates on the secondary display device.

In an additional aspect of the disclosure, an electronic apparatus includes means, executable by a rich user device, for receiving selection of one or more information sets maintained through the rich user device to share with one or more secondary display devices associated with the rich user device, means, executable by the rich user device, for identifying current data associated with the selected one or more information sets, and means, executable by the rich user device, for sending the identified current data to the one or more secondary display devices for display.

In an additional aspect of the disclosure, an electronic apparatus includes means, executable by a secondary display device, for receiving one or more information sets from a rich user device, wherein the secondary display device has a dedicated communication pairing with the rich user device, means for displaying the one or more information sets on the secondary display device, means, executable by the secondary display device, for receiving updates to the one or more information sets from the rich user device, and means for replacing the one or more information sets with the received updates on the secondary display device.

In an additional aspect of the disclosure, a computer program product has a computer-readable medium having program code recorded thereon. This program code includes code, executable at a rich user device, to receive selection of one or more information sets maintained through the rich user device to share with one or more secondary display devices associated with the rich user device, code, executable by the rich user device, to identify current data associated with the selected one or more information sets, and code, executable by the rich user device, to send the identified current data to the one or more secondary display devices for display.

In an additional aspect of the disclosure, a computer program product has a computer-readable medium having program code recorded thereon. This program code includes code, executable by a secondary display device, to receive one or more information sets from a rich user device, wherein the secondary display device has a dedicated communication pairing with the rich user device, code to display the one or more information sets on the secondary display device, code, executable by the secondary display device, to receive updates to the one or more information sets from the rich user device, and code to replace the one or more information sets with the received updates on the secondary display device.

In an additional aspect of the disclosure, a rich user device includes at least one processor and a memory coupled to the processor. The processor is configured to receive selection of one or more information sets maintained through the rich user device to share with one or more secondary display devices associated with the rich user device, to identify current data associated with the selected one or more information sets, and to send the identified current data to the one or more secondary display devices for display.

In an additional aspect of the disclosure, a secondary display device includes at least one processor and a memory coupled to the processor. The processor is configured to receive one or more information sets from a rich user device, wherein the secondary display device has a dedicated communication pairing with the rich user device, to display the one or more information sets on the secondary display device, to receive updates to the one or more information sets from the rich user device, and to replace the one or more information sets with the received updates on the secondary display device.

### BRIEF DESCRIPTION OF THE DRAWINGS

FIG. 1 is a block diagram illustrating an electronic device configured according to one aspect of the present disclosure.

FIG. 2 is a block diagram illustrating secondary display devices configured according to one aspect of the present disclosure.

FIG. 3 is a block diagram illustrating a secondary display configured according to one aspect of the present disclosure.

FIG. 4 is a block diagram illustrating a secondary display device configured according to one aspect of the present disclosure.

FIG. 5 is a functional block diagram illustrating example blocks executed to implement one aspect of the present disclosure.

FIG. 6 is a functional block diagram illustrating example blocks executed to implement one aspect of the present disclosure.

FIG. 7 is a block diagram illustrating a secondary display device configured according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

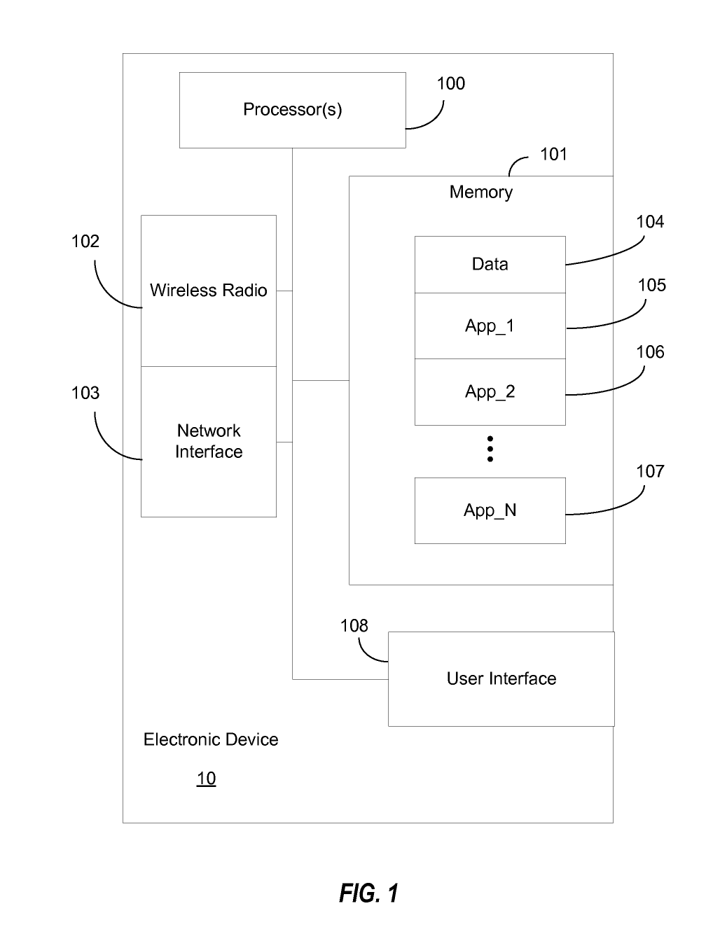

FIG. 1 is a block diagram illustrating an electronic device 10 configured according to one aspect of the present disclosure. Electronic device 10 includes various components common to many typical smart phones, tablet computers, notebook and netbook computers, computers, and the like. Devices, such as electronic device 10 include the processing power, memory, and programming to perform complex tasks, run complex programs, and interact substantially with a user, and may be also referred to herein as rich user devices.

The functionality and operations of electronic device 10 are controlled and executed through processor(s) 100. Processor(s) 100 may include one or more core processors, central processing units (CPUs), graphical processing units (GPUs), math co-processors, and the like. Processor(s) 100 executes program logic, whether implemented through software stored in a memory 101 or in firmware in which logic is integrated directly into integrated circuit components. Electronic device 10 may communicate wirelessly through various radios, such as wireless radio 102, such as one or more of wireless wide area network (WWAN) radios and wireless local area network (WLAN) radios, such as WIFI™ radios, BLUETOOTH® radios, and the like. If a WWAN radio is included as one of the radios in wireless radio 102, communication would generally be allowed to communicate over a long range wireless communication network such as 3G, 4G, LTE, and the like. Various WLAN radios, such as WIFI™ radios, BLUETOOTH® radios, and the like, would allow communication over a shorter range. Electronic device 10 may also provide communication and network access through a wired connection with network interface 103. The wired connection may connect to the publicly-switch telephone network (PSTN), or other communication network, in order to connect to the Internet or other accessible communication network.

Under control of processor(s) 100, program logic stored on memory 101, including data 104, application_1 105-application_N 107, provides functionality of electronic device 10 including communications, Internet access, and execution of various programs for productivity, entertainment, and the like. For example, applications stored in memory 101 may, when executed by processor(s) 100, operate calendar programs, game programs, list programs, social media programs, web browsers, and the like. Such operating applications are displayed visually to the user via user interface component 108. The user interface component 108 includes various hardware and software applications that control the rendering of visual information onto the display screen of the mobile device (not shown). The user interface component 108, under control of the processor(s) 100, controls and operates all forms of interfaces between the user and electronic device 10. Thus, for example, when electronic device 10 is implemented using a touch screen display, user interface component 108 reads the user's input and finger motions on the touch screen and translates those movements or gestures into electronic interface navigational commands and data entry. Various aspects of user interface component 108 also will receive the rendered visual data through processing, controlled by processor(s) 100, and display that visual information on the display. Thus, during input to a touch screen device, the user interface component 108 may be receiving and analyzing input data from a user's finger movements and gestures on the display screen. It may also be receiving data from the processor(s) 100 in the form of processed visual or sound data to be output by display to the user, some of which may be to reflect movement of screen objects in response to the user's finger movements.

Various aspects of the present disclosure provide for sharing user interface information through a secondary remote display. In this communication paradigm, a rich user device (mobile phone, desktop computer, laptop, tablet, etc.), such as electronic device 10, is paired with a simple secondary display device. The secondary display device provides a thin client display for displaying designated information pushed from the associated rich user device. For example, application_2 106, stored in memory 101 of electronic device 10 is an information sharing application. The user would select application_2 106 to run on electronic device 10. Application_2 106 includes code that specifically identifies the address of one or more specific, dedicated secondary display devices (not shown). These secondary display devices are thin client-type devices, with minimal processing power. Their main purpose is to display a few pieces of information to the user in possession of the secondary device. Moreover, the secondary display device may be preprogrammed with communication parameters that allow the secondary device to communicate specifically with the sharing application, application_2 106, running on electronic device 10, or similar sharing applications running on other rich user devices.

The sharing interface on electronic device 10, created through execution of application_2 106, allows the user to designate particular information to be shared with the secondary display device. Once the information is designated, electronic device 10 will begin to send that information to the secondary display device for display. This information could be a calendar, task list, a message board, location, emoticon, and the like. As this information is updated on electronic device 10 from time to time, the updates are also transmitted to the secondary display device for display. This shared information may be transmitted wirelessly, using wireless radio 102, or through a wireline connection to the Internet, using network interface 103.

In order to keep the device simple, a limited amount of information would be provided to the secondary device. For example, a user might designate to share only calendar information, or might only share a task list and location. Various different combinations maybe provided for, while maintaining as simple an interface as possible. As a simple device, the secondary display device would also be configured for minimal user interaction. A user might be limited only to turning the device off and on, or changing the size of the displayed information.

More than one secondary display device may be paired with the rich user device. This would allow the user of the rich user device to provide a secondary display device to multiple people or for someone to have in multiple locations. With multiple secondary display devices paired with the rich user device, the user may select different types of information to share to each secondary display device, such that the secondary display given to one person may display calendar information, while the secondary display device given to another person may display location or a message board.

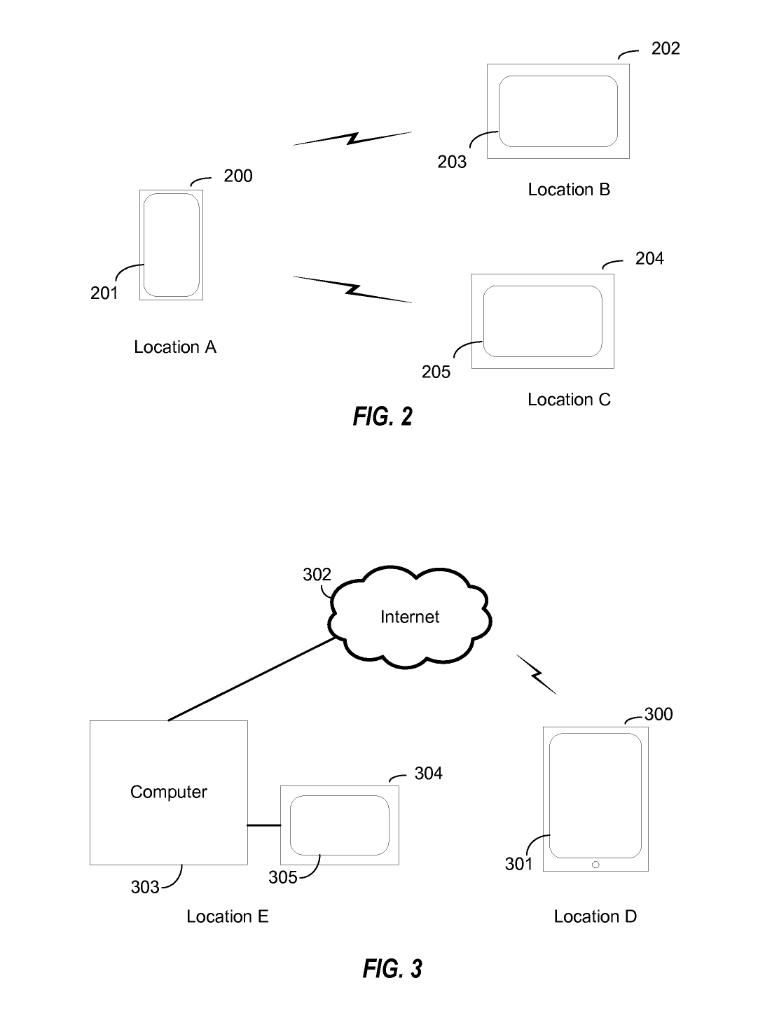

FIG. 2 is a block diagram illustrating secondary display devices 202 and 204 configured according to one aspect of the present disclosure. For purposes of the example illustrated in FIG. 2, a rich user device 200, including a display 201, belongs to a teenage boy user. The rich user device 200 may be a smart phone, a tablet computer, or the like. The teenage user obtains two secondary display devices 202 and 204, that he wishes to pair with rich user device 200 in order to share information. The secondary display devices 202 and 204 each include displays 203 and 205, respectively. The displays 201, 203, and 205 may each be typical flat screen display screens and may be implemented as touch screens, to receive input or interaction through direct manipulation of displayed interface objects or elements. Through operation of an information sharing application on rich user device 200, the user pairs secondary display devices 202 and 204 with rich user device 200. Preprogrammed code on secondary display devices 202 and 204 allow the pairing parameters to be exchanged between the devices.

Through input to the rich user device 200, the user designates specific information that he wants to share with the secondary display devices 202 and 204. For example, the user selects to share location information with secondary display device 202 and selects to share social media status updates with secondary display device 204. Upon selection of these types of information to share, rich user device 200 begins to transmit the shared information to each of secondary display devices 202 and 204. When turned on, secondary display device 202 will begin to display the location information of rich user device 200 on display 203, while secondary display device 204 will begin to display social media status updates by the user.

After pairing the secondary display devices 202 and 204 with rich user device 200, the user gives secondary display device 202 to his parents and gives secondary display device 204 to his girlfriend. The user's parents set up secondary display device 202 at their home, Location B, and the user's girlfriend sets up secondary display device 204 in her room, Location C. Rich user device 200, at Location A, with the user will transmit information updates for all of the information that has been designated for sharing. For example, while the user and rich user device 200 are at Location A, the updated location information, Location A, will be transmitted to secondary display device 202, at Location B, and displayed on display 203. Therefore, the user's parents may find out where there user is by viewing the location information being shared and displayed on display 203.

The user also enters his social media status updates on rich user device 200. When his updates have been entered, this updated information is transmitted to secondary display device 204, at Location C, and displayed on display 205. The user's girlfriend may then see the user's status updates by referencing the updated status information on display 205.

Secondary display devices 202 and 204 do not include independent communication functionality. That is, the party in possession of either of secondary display devices 202 and 204 may not communicate to rich user device 200 through secondary display devices 202 and 204. The communication paradigm defined through pairing of the devices provides for the information to be shared one-way, from the rich user device 200 to the secondary display devices 202 and 204.

In another aspect of the present disclosure, preset actions may be selected, such that when the user of a rich user device performs some action or arrives at a particular location, preset data may be shared with the associated secondary display device. For example, the user of rich user device 200 selects that location information will automatically be sent to secondary display device 202 when rich user device 200 arrives at a particular location. Location A may be the apartment of the user of rich user device 200. Secondary display device 202 is in the possession of the user's father at Location B. Thus, as soon as rich user device 200 arrives home with the user, a presence indication at Location A is sent to secondary display device 202.

FIG. 3 is a block diagram illustrating a secondary display device 304 configured according to one aspect of the present disclosure. A user of rich user device 300, having a display 301, has designated to share calendar information with a secondary display device 304. Rich user device 300 may be a tablet computer, netbook, or the like that the user maintains at his or her home, Location D. The user sets up the secondary display device 304 at his or her office, Location E, connected to a computer 303. The secondary display device 304 connects to the computer 303 using a wired connection, such as a universal serial bus (USB), an IEEE 1394 connection, an Ethernet connection, or the like. The computer 303 is also connected via a wireline connection to the Internet 302. When calendar items arise on rich user device 300, those updated information items are transmitted via Internet 302 to secondary display device 304, through its connection to the Internet 302 through computer 303. This updated calendar information is then displayed on display 305. In such an arrangement, a user may maintain a home calendar on rich user device 300 that is completely separate from any calendar application running on his or her work computer, computer 303. The calendar information from rich user device 300 is shared with secondary display device 304, which is then displayed for the user at Location E.

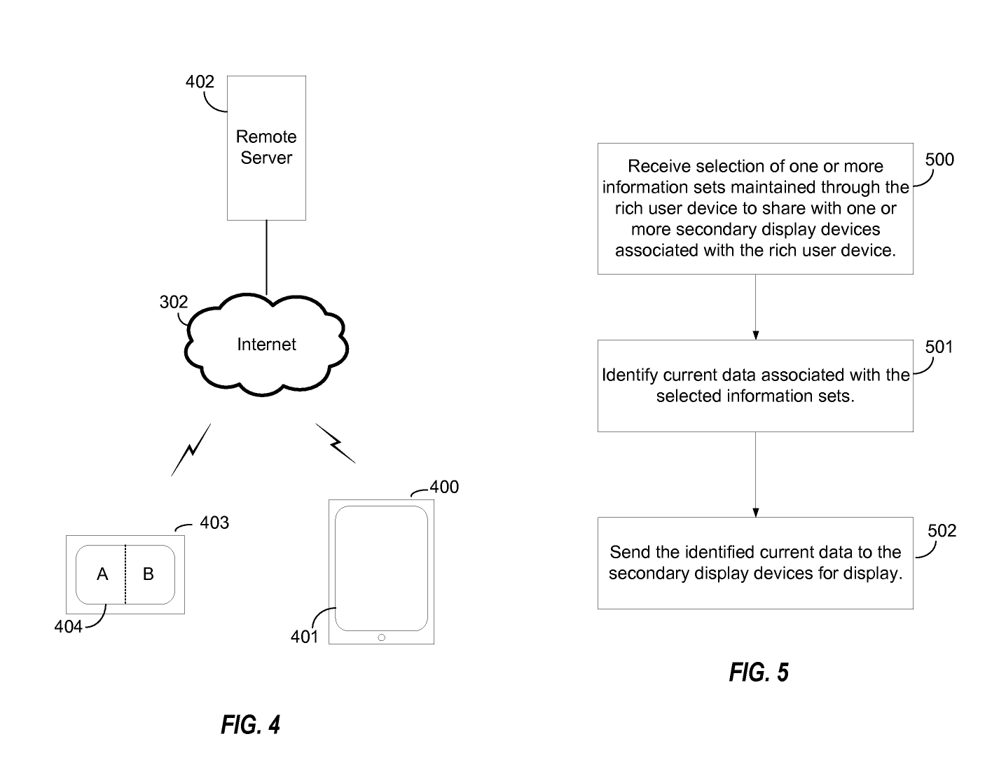

FIG. 4 is a block diagram illustrating a secondary display device 403 configured according to one aspect of the present disclosure. A user of rich user device 400, having a display 401, has selected to share multiple sets of information with the secondary display device 403. With two sets of shared information, the display 404 on secondary display device 403 is visually divided into two portions, Section A and Section B. As the secondary display device 403 receives the information and information updates, one set of information will be displayed on Section A of display 404, while the other set of information will be displayed on Section B of display 404. Thus, the user in possession of secondary display device 403 may reference the display 404 to view a display of both sets of shared information updates.

One set of information that the user of rich user device 400 has selected to share with secondary display device 403 is status update information for a social media application. Another set of information that the user has selected to share is location information. The location information is determined and maintained at rich user device 400. Rich user device 400 includes a global positioning satellite (GPS) radio (not shown) that includes the capability to calculate the location of the rich user device 400. As this location information is changed and updated, the updated location information is sent to secondary display device 403 to be displayed on Section A of display 404.

In contrast, the status update information for the social media application is not necessarily maintained by rich user device 400. The user of rich user device 400 may input data through touch screen display 401 that is transmitted to a remote server 402 that maintains the data associated with the social media application. A local version of the social media application is stored and executed on rich user device 400. However, the data representing the status update information is only temporarily stored on rich user device 400 during operating instances of the social media application running locally on rich user device 400. The data represented the status update information is transmitted through Internet 302 to the remote server 402. This data is transmitted in a specific format that the social media application recognizes and is able to visibly populate into the user interface of the social media application. When this type of information is selected to be shared with secondary display device 403, the sharing application operating on rich user device 400 recognizes the format of the data representing the status updates and sends a copy of this information also to secondary display device 403 through Internet 302. The display interface code preprogrammed into the secondary display device 403 understands this social media data format and includes further program code that displays the status updates in a meaningful way onto the display 404, in this example, at Section B of display 404.

FIG. 5 is a functional block diagram illustrating example blocks executed to implement one aspect of the present disclosure. In block 500, a rich user device receives selection from a user of one or more information sets maintained through the rich user device to share with one or more secondary display devices associated with the rich user device. The user interacts with the interface of an operating information sharing application on the rich user device in order to select this information. The rich user device identifier, in block 501, current data from the selected one or more information sets. In block 502, the rich user device sends the identified current data to the one or more secondary display devices for display. Once identified, the rich user device begins to share the selected information by sending the current data of the selected information to the secondary display devices.

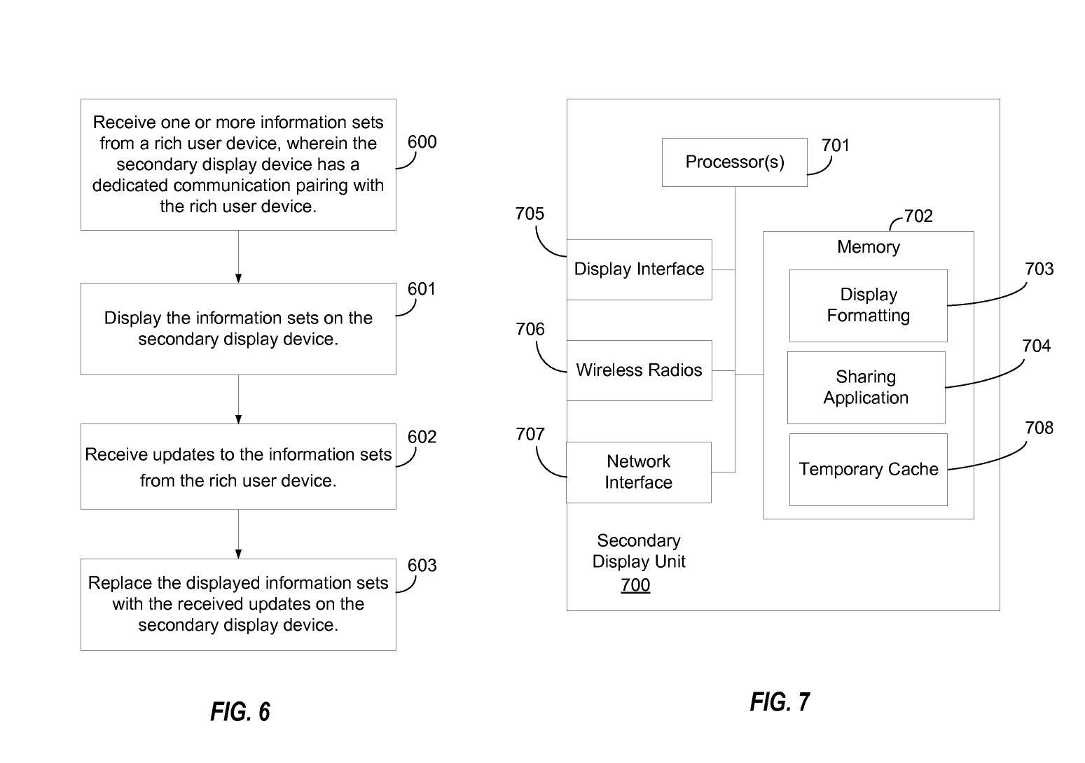

FIG. 6 is a functional block diagram illustrating example blocks executed to implement one aspect of the present disclosure. In block 600, a secondary display device receives one or more information sets from a rich user device. The secondary display device is associated with and has a dedicated communication pairing with the rich user device. The secondary display device displays the received information sets on a display of the secondary display device in block 601. In block 602, the secondary display device receives updates to the information sets from the rich user device. The secondary display device then replaces the information sets, in block 603, with the received updates on the secondary display device. Thus, the secondary display devices receives and displays information from the rich user device as it is updated through the rich user device.

With reference back to FIG. 1, when the user of the electronic device 10 acts to select the various sets of information to share with one or more of the secondary display devices, the user interacts with the input components operated through user interface component 108, under control of the processor(s) 100, of the electronic device 10. The combination of these components provides means for receiving selection of one or more information sets maintained through the rich user device to share with one or more secondary display devices associated with the rich user device.

As noted above, application_2 106 was identified as an information sharing application that operates, as executed by the processor(s) 100. The executing information sharing application identifies the data 104 representing the information sets that were selected by the user. The combination of these components provides means for identifying current data associated with the selected information sets.

The executing information sharing application, under control of the processor(s) 100, sends the identified data for the selected information sets to the one or more secondary display devices using one or both of the wireless radio 102 and network interface 103. The combination of these components provides means for sending the identified current data to the one or more secondary display devices for display. As updates to this information occur and are identified at the electronic device 10, the executing information sharing application, under control of the processor(s) 100 will send the updates to the associated secondary display devices through the wireless radio 102 and/or network interface 103.

FIG. 7 is a block diagram illustrating a secondary display device 700 configured according to one aspect of the present disclosure. Secondary display device 700 includes a processor(s) 701 that controls and executes the functionalities and features provided by secondary display device 700. Secondary display device 700 may be an electronic device with limited functionality. For example, secondary display device 700 may receive and display information without providing the capability for a user in possession of secondary display device 700 to do more than turn the device on and off and change the arrangement of the view of the displayed information. Secondary display device 700 includes memory 702, coupled to processor(s) 701. Memory 702 contains software, program code, data, and the like which the processor(s) 701 may access and execute to implement any of the functions of secondary display device 700. For example, memory 703 contains display formatting 703, a sharing application 704, and a temporary cache 708, which temporarily stores the received data and information for display on the secondary display device 700. Secondary display device 700 includes communication capabilities through wireless radios 706 and network interface 707. Wireless radios 706 include multiple radios to facility communication of the various protocols, including WWAN communication, WLAN communications, such as WIFI™, BLUETOOTH®, WIFI™ Direct, BLUETOOTH® Low Energy (LE), ZIGBEE®, and the like.

Processor(s) 701 executes the sharing application 704 in memory 702 to operate the sharing functionality of the secondary display device 700. Under control of processor(s) 701, wireless radios 706 and network interface 707 send and receive data and communication signals over various types of protocols. The combination of these components provides means for receiving one or more information sets from a rich user device. The secondary display device has a dedicated communication pairing with the rich user device.

When the information has been received by secondary display device 700, processor(s) 701, in operating the sharing application 704, accesses the display formatting 703 for the display parameters to use in controlling display interface 705 to display the received information onto the embedded display. The combination of these components provides means for displaying the received information sets on the secondary display device.

As the information is updated or changes at the rich user device, the secondary display device receives the update through one or both of the wireless radios 706 and the network interface 707, under control of the processor(s) 701, and stored into the temporary cache 708, replacing the current information that is currently being displayed. The combination of these components provides the means for receiving updates to the information sets from the rich user device.

As the updated information replaces the current data in the temporary cache 708, processor(s) 701 accesses the display formatting 703 for use with the display interface 705 to display the updated information onto the embedded display. The combination of these components provide means for replacing the information sets with the received updates on the secondary display device.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 5 and 6 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary designs, the functions described may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for sharing information, comprising:
receiving, at a rich user device, selection of one or more information sets maintained through the rich user device to share with one or more secondary display devices associated with the rich user device;
identifying, by the rich user device, current data associated with the selected one or more information sets; and
sending, by the rich user device, the identified current data to the one or more secondary display devices for display.

2. The method of claim 1, further comprising:
detecting new data in the selected one or more information sets; and
transmitting the detected new data to the one or more secondary display devices for display.

3. The method of claim 1, wherein the one or more information sets comprise one or more of:
calendar information;
message board information;
location information;
photos;
task list information; and
social media information.

4. The method of claim 1, further comprising:
receiving selection of an additional one or more information sets maintained on the rich user device to share with one or more additional secondary display devices associated with the rich user device;
identifying additional current data from the additional one or more information sets; and
transmitting the identified additional current data to the one or more additional secondary display devices for display.

5. The method of claim 1, further comprising:
establishing, by the rich user device, a dedicated communication pairing between the rich user device and the associated one or more secondary display devices.

6. The method of claim 1, wherein the sending is performed automatically in response to a preselected event.

7. The method of claim 6, wherein the preselected event comprises one or more of:
entry to a location;
receipt by the rich user device of predetermined data; and
arrival at a predetermined time.

8. A method for sharing information, comprising:
receiving, by a secondary display device, one or more information sets from a rich user device, wherein the secondary display device has a dedicated communication pairing with the rich user device;
displaying the one or more information sets on the secondary display device;
receiving, by the secondary display device, updates to the one or more information sets from the rich user device; and
replacing the one or more information sets with the received updates on the secondary display device.

9. The method of claim 8, wherein each of the one or more information sets is displayed in an associated section of the secondary display device.

10. The method of claim 8, further comprising:
establishing, by the secondary display device, a dedicated communication pairing between the rich user device and the secondary display devices.

11. The method of claim 8, wherein the one or more information sets and the updates are received wirelessly by the secondary display device.

12. An electronic apparatus comprising:
means, executable by a rich user device, for receiving selection of one or more information sets maintained through the rich user device to share with one or more secondary display devices associated with the rich user device;
means, executable by the rich user device, for identifying current data associated with the selected one or more information sets; and
means, executable by the rich user device, for sending the identified current data to the one or more secondary display devices for display.

13. The electronic apparatus of claim 12, further comprising:
means for detecting new data in the selected one or more information sets; and
means for transmitting the detected new data to the one or more secondary display devices for display.

14. The electronic apparatus of claim 12, wherein the one or more information sets comprise one or more of:
calendar information;
message board information;
location information;
photos;
task list information; and
social media information.

15. The electronic apparatus of claim 12, further comprising:
means for receiving selection of an additional one or more information sets maintained on the rich user device to share with one or more additional secondary display devices associated with the rich user device;
means for identifying additional current data from the additional one or more information sets; and
means for transmitting the identified additional current data to the one or more additional secondary display devices for display.

16. The electronic apparatus of claim 12, further comprising:
means, executable by the rich user device, for establishing a dedicated communication pairing between the rich user device and the associated one or more secondary display devices.

17. The electronic apparatus of claim 12, wherein the means for sending is executed automatically in response to a preselected event.

18. The electronic apparatus of claim 17, wherein the preselected event comprises one or more of:
entry to a location;
receipt by the rich user device of predetermined data; and
arrival at a predetermined time.

19. An electronic apparatus comprising:
means, executable by a secondary display device, for receiving one or more information sets from a rich user device, wherein the secondary display device has a dedicated communication pairing with the rich user device;
means for displaying the one or more information sets on the secondary display device;
means, executable by the secondary display device, for receiving updates to the one or more information sets from the rich user device; and
means for replacing the one or more information sets with the received updates on the secondary display device.

20. The electronic apparatus of claim 19, wherein each of the one or more information sets is displayed in an associated section of the secondary display device.

21. The electronic apparatus of claim 19, further comprising:
means, executable by the secondary display device, for establishing a dedicated communication pairing between the rich user device and the secondary display devices.

22. The electronic apparatus of claim 19, wherein the one or more information sets and the updates are received wirelessly by the secondary display device.

23. A computer program product comprising:
a non-transitory computer-readable medium having program code recorded thereon for mirrored interface navigation on a plurality of mobile devices, the program code comprising:
program code, executable at a rich user device, to receive selection of one or more information sets maintained through the rich user device to share with one or more secondary display devices associated with the rich user device;
program code, executable by the rich user device, to identify current data associated with the selected one or more information sets; and
program code, executable by the rich user device, to send the identified current data to the one or more secondary display devices for display.

24. The computer program product of claim 23, further comprising:
program code to detect new data in the selected one or more information sets; and
program code to transmit the detected new data to the one or more secondary display devices for display.

25. The computer program product of claim 23, wherein the one or more information sets comprise one or more of:
calendar information;
message board information;
location information;
photos;
task list information; and
social media information.

26. The computer program product of claim 23, further comprising:
program code to receive selection of an additional one or more information sets maintained on the rich user device to share with one or more additional secondary display devices associated with the rich user device;
program code to identify additional current data from the additional one or more information sets; and
program code to transmit the identified additional current data to the one or more additional secondary display devices for display.

27. The computer program product of claim 23, further comprising:
program code, executable by the rich user device, to establish a dedicated communication pairing between the rich user device and the associated one or more secondary display devices.

28. The computer program product of claim 23, wherein the program code to send is executed automatically in response to a preselected event.

29. The computer program product of claim 28, wherein the preselected event comprises one or more of:
entry to a location;
receipt by the rich user device of predetermined data; and
arrival at a predetermined time.

30. A computer program product comprising:
a non-transitory computer-readable medium having program code recorded thereon for mirrored interface navigation on a plurality of mobile devices, the program code comprising:
program code, executable by a secondary display device, to receive one or more information sets from a rich user device, wherein the secondary display device has a dedicated communication pairing with the rich user device;
program code to display the one or more information sets on the secondary display device;
program code, executable by the secondary display device, to receive updates to the one or more information sets from the rich user device; and
program code to replace the one or more information sets with the received updates on the secondary display device.

31. The computer program product of claim 30, wherein each of the one or more information sets is displayed in an associated section of the secondary display device.

32. The computer program product of claim 30, further comprising:
program code, executable by the secondary display device, to establish a dedicated communication pairing between the rich user device and the secondary display devices.

33. The computer program product of claim 30, wherein the one or more information sets and the updates are received wirelessly by the secondary display device.

34. A rich user device comprising:
at least one processor;
a memory coupled to the at least one processor; and
a display device coupled to the at least one processor;
wherein the at least one processor is configured:
to receive selection of one or more information sets maintained through the rich user device to share with one or more secondary display devices associated with the rich user device;
to identify current data associated with the selected one or more information sets; and
to send the identified current data to the one or more secondary display devices for display.

35. The rich user device of claim 34, wherein the at least one processor is further configured:
to detect new data in the selected one or more information sets; and
to transmit the detected new data to the one or more secondary display devices for display.

36. The rich user device of claim 34, wherein the one or more information sets comprise one or more of:
calendar information;
message board information;
location information;
photos;
task list information; and
social media information.

37. The rich user device of claim 34, wherein the at least one processor is further configured:
to receive selection of an additional one or more information sets maintained on the rich user device to share with one or more additional secondary display devices associated with the rich user device;
to identify additional current data from the additional one or more information sets; and
to transmit the identified additional current data to the one or more additional secondary display devices for display.

38. The rich user device of claim 34, wherein the at least one processor is further configured:
to establish a dedicated communication pairing between the rich user device and the associated one or more secondary display devices.

39. The rich user device of claim 34, wherein the configuration of the at least on processor to send is executed automatically in response to a preselected event.

40. The rich user device of claim 39, wherein the preselected event comprises one or more of:
entry to a location;
receipt by the rich user device of predetermined data; and
arrival at a predetermined time.

41. A secondary display device comprising:
at least one processor;
a memory coupled to the at least one processor; and
a display device coupled to the at least one processor;
wherein the at least one processor is configured:
to receive one or more information sets from a rich user device, wherein the secondary display device has a dedicated communication pairing with the rich user device;
to display the one or more information sets on the secondary display device;
to receive updates to the one or more information sets from the rich user device; and
to replace the one or more information sets with the received updates on the secondary display device.

42. The secondary display device of claim 41, wherein each of the one or more information sets is displayed in an associated section of the secondary display device.

43. The secondary display device of claim 41, wherein the at least one processor is further configured:
to establish a dedicated communication pairing between the rich user device and the secondary display devices.

44. The secondary display device of claim 41, wherein the one or more information sets and the updates are received wirelessly by the secondary display device.
